(19) United States
(12) Patent Application Publication
(10) Pub. No.: US 2024/0029080 A1
(43) Pub. Date: Jan. 25, 2024

(54) DEVICE AND METHOD FOR AUTHENTICATING PRODUCTS

(71) Applicant: VERITISE, PARIS (FR)

(72) Inventor: Cormac LUCKING, LES SABLES D'OLONNE (FR)

(21) Appl. No.: 18/256,810

(22) PCT Filed: Dec. 8, 2021
(86) PCT No.: PCT/EP2021/084799

§ 371 Date: Jun. 9, 2023

(30) Foreign Application Priority Data
Dec. 10, 2020 (FR) FR2012995

(51) Int. Cl. G06Q 30/018; G06Q 20/32; G06Q 20/36; G06Q 20/38; H04L 9/08

(52) U.S. Cl. CPC G06Q 30/0185; G06Q 20/3276; G06Q 20/36; G06Q 20/3823; G06Q 20/3829; H04L 9/0825

(57) ABSTRACT

Disclosed is a method for authenticating a product by a computer system including a computer register organised in blockchain. The method includes steps of: generating, by a digital wallet holder, a transaction to be written in the computer register which includes at least one digital wallet address and a public key; writing, on a first label, a first graphic element in which the public key is encoded; writing, on a second label, a second graphic element in which the private key is encoded; and affixing the first and second labels on the product such that the first graphic element is visible and the second graphic element is invisible.

### TECHNICAL FIELD OF THE INVENTION

The present invention generally relates to the field of solutions for authentication and traceability of marketable goods.

More precisely, it relates to a method and a device for authenticating products on which labels have been affixed.

It also relates to any product bearing such labels.

### STATE OF THE ART

Counterfeiting concerns all sectors of economic activity.

In order to face this situation, authentication and traceability of products become major issues.

Authentication and traceability solutions thus aim at acquiring a certain level of certainty as to the authenticity of a product.

For that purpose, these solutions are generally based on identification elements that can be classified into three different technologies:
visually controllable elements (e.g. anti-tampering devices, holograms, inks, etc.),
laboratory controllable elements (physical markers, biological markers, etc.), and
elements that can be controlled using portable tools (e.g. digital markers, nanoparticles, etc.).

Currently, most of the identification elements that can be controlled using portable tools are either very complicated to implement, and therefore not widely usable, or not secure enough so that they are susceptible to tampering.

There is therefore a need for new authentication means.

### DISCLOSURE OF THE INVENTION

In this context, the present invention proposes to use “blockchain” technology and asymmetric cryptology to find an easily usable solution that offers its users a high level of safety.

Blockchain technology can be defined here in general terms as a computer system including a computer register that is organized in a chain of blocks (“blockchain”) and in which data associated with computer wallet holders can be written.

In this context, the present invention more precisely proposes a method for authenticating a product, which comprises steps of:
generating, by a digital wallet holder, a transaction to be registered in the computer register, said registration comprising at least one address of the digital wallet and a public key, said public key being associated with a private key,
writing, on a first label, a first graphic element in which said public key is encoded,
writing, on a second label, distinct or not from the first label, a second graphic element in which said private key is encoded,
affixing the first and second labels on said product, in such a way that the first graphic element is visible and the second graphic element is invisible as long as said second label and/or the product remain intact.

Thus, thanks to the invention, the public key encoded on the first label makes it possible to control that the product has actually been manufactured by the manufacturer holding the digital wallet and that this product has not yet been the subject of any transaction.

The private key, which can be read only once the product has been open or the second label corrupted, is used to generate a second transaction to be written in the computer register in order to record therein the product sale. Thus, anyone who would like to reuse the public key to counterfeit another product would fail, because this public key would then be associated with an already sold product.

It is further understood that, thanks to the invention, the product cannot be resold without the new buyer knowing about the first transaction.

Preferentially, one at least of the first and second graphic elements is in the form of a bar code or a two-dimensional code, e.g. a QR-code.

Preferentially, said registration also comprises at least another data item, which relates to the product and/or the manufacturer of said product.

The invention also relates to a method for checking the authenticity of a product, comprising the steps of:
making a preliminary check of the product authenticity by reading the first graphic element and decoding the public key,
corrupting the second label or the product in such a way as to make the second graphic element visible,
making a complementary check of the product authenticity by reading the second graphic element and decoding the private key, wherein the private key decoding automatically causes the writing of a transaction in the computer register.

Preferentially, an additional step is provided, of acquiring data that relate to an individual acquiring said product and that have been previously entered on a man-machine interface.

Preferentially, an additional step is provided, in which a guarantee associated with the product is generated.

Preferentially, each additional step is automatically implemented after the complementary check step.

The invention also relates to an authentication device comprising:
a first label on which is written a first graphic element in which a public key is encoded, said public key being stored into a computer register organized in a blockchain, and
a second label on which is written a second graphic element in which a private key associated with said public key is encoded.

The invention finally relates to a product provided with such an authentication device, the first label of which is affixed in such a way that the first graphic element is visible, and the second label of which is affixed in such a way that the second graphic element is invisible as long as said second label and/or the product remain intact.

Preferentially, said second label can be peeled off only once from the product, or has a coating that hides the second graphic element and that can be removed only once, or is affixed in such a way as to be visible only once the product has been open.

Obviously, the different features, alternatives and embodiments of the invention can be associated with each other according to various combinations, insofar as they are not incompatible or exclusive with respect to each other.

### DETAILED DESCRIPTION OF THE INVENTION

The following description in relation with the appended drawings, given by way of non-limiting examples, will allow a good understanding of what the invention consists of and of how it can be implemented.

In the appended drawings:

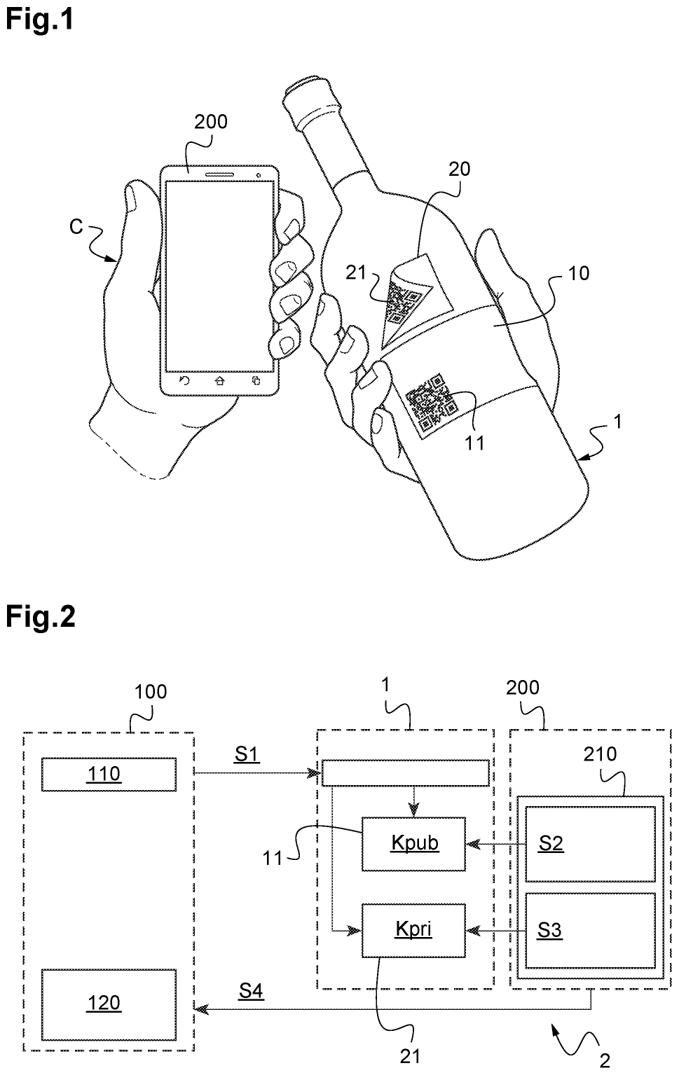

FIG. 1 is a schematic view of a product that includes an authentication device according to the invention, and a portable phone used to implement an authentication method according to the invention; and

FIG. 2 is a diagram illustrating the different entities used to implement this authentication method.

FIG. 1 shows an example of product 1 that is desired to be more easily authenticable at the time of purchase.

FIG. 2 shows the different elements of a system for ensuring this authentication.

This authentication system 2 will be first described.

It comprises the following combination:
at least one product 1 to be authenticated, on which are affixed two label parts 10, 20 (see FIG. 1),
a customer terminal 200 that allows a customer to interact with product 1, to authenticate the latter, and
a set of authentication and traceability servers 100, comprising in particular the server of a central entity (called hereinafter Trusted third party A).

A this stage, the notion of “Trusted third party A” can be defined as denoting a certification body for the certification of Companies B that want to market products using the solution which is the subject of the present invention.

The notion of “Company B” will here be used only to denote the entities that want to market products using the solution which is the object of the present invention.

Finally, the notion of “Customer C” can also be defined. In the description, this word of customer won't apply to the intermediate companies belonging to the marketing chains of the products marketed by Companies B. On the contrary, it will apply only to the final customers, i.e. the persons or companies that acquire the products to use them.

Each of the authentication and traceability servers 100 stores a copy of a computer register that is organized in a chain of blocks. In the following of the description, the word “blockchain” will be used.

The blockchain is thus stored on a peer-to-peer network composed of a plurality of nodes (each formed by one or several servers) that form together a distributed database. More precisely, the blockchain is stored in this distributed database by being replicated in each node. At each node is implemented a computer protocol for participation in blockchain development. This protocol, called “blockchain protocol”, comprises a computational process for periodic addition of a new block 120 to the existing blockchain. The process implements a mechanism of block validation by consensus between all or part of the nodes. That is the cross-correlation of the blocks that provides their reputation of immutability to the data contained in the blockchain.

The blockchain protocol here makes it possible to complete the blockchain by registering therein in particular three types of information:
data corresponding to transactions for the sale of products 1 by Companies B,—data corresponding to transactions for the purchase of products 1 by Customers C, and
registration and identification data for Companies B authorized to emit transactions for the sale of products on the blockchain.

The way to write such information in the blocks will be described in detail hereinafter. It can only be stated at this stage that the registration and identification data for Companies B will be in the form of digital wallets 110 over each of which only the Company B concerned will have control.

The authentication and traceability servers 100 are connected together, here via a WAN or “Wide Area Network” (i.e. advantageously Internet).

The customer terminal 200 and the authentication and traceability servers 100 are also intended to communicate together via this same network.

The customer terminal 200 can for example be in the form of a computer, a tablet, a connected watch . . . . It will be considered here that it is a mobile phone 200.

Thus, it will be considered in our example that each Customer C who wishes to benefit from the advantages of the present invention will be equipped with a mobile phone 200.

This mobile phone 200 is very classical in that it includes a man-machine interface (typically a touch screen), a calculator (typically a microprocessor), a computer memory, communication means and an image acquisition means.

The calculator stores a computer application App, consisted of computer programs comprising instructions whose execution by the processor allows the implementation by the calculator of the method described hereinafter.

This computer application App will have been here elaborated by the Trusted third party A and made available to Customers C.

It will be noted that a computer software Log elaborated by the trusted third party will also be made available to Companies B.

Product 1 to be authenticated will now be described in more detail with reference to FIG. 1.

This product can be formed by any type of marketable element or set of elements.

In FIG. 1, it is a bottle of red wine, but as an alternative, it could be a garment, a container, a book, a car or plane component, a laptop . . . . This list is obviously not limiting.

In the following of the description, the notion of “product” will of course refer to marketable goods (here the wine bottle), but it may also include the protective packaging for these goods. By way of example, when the bottle of wine is delivered in a closed wooden box, the notion of product may apply to the unit formed by the bottle and its box.

This product 1 is provided with an authentication device here formed of two labels 10, 20. These two labels are here distinct, but as an alternative, they could be formed one-piece.

These labels 10, 20 are intended to be affixed on or in product 1 for its authentication and traceability.

By “authentication”, it is meant in particular the action that consists in checking the product originality.

By “traceability”, it is meant in particular the ability to know whether or not the product has already been sold to a Customer C.

The first label 10 is coated with a first graphic element 11 encoding information. It is affixed on product 1 in such a way that the first graphic element 11 is visible. In our example, it is directly stuck on the wine bottle, in such a way that its side having the first graphic element 11 located thereon is turned outwards. As an alternative, if the product were packaged (opaque protective film, box, carton), this first label 10 would be preferentially affixed on this packaging in such a way that the first graphic element 11 is well visible.

The second label 20 is coated with a second graphic element 21 encoding information. It is affixed on the product in such a way that the second graphic element 21 is invisible. In our example, it is directly stuck on the wine bottle, in such a way that its side having the second graphic element 21 located thereon is turned inwards (the red wine hiding this graphic element). As an alternative, if both labels were formed one-piece, both graphic elements would be, in this example, located on the two opposite sides of this label. According to another alternative, if the product were packaged, this second label 20 could be affixed on the inner side of this packaging or simply slipped into the packaging.

The objective is that the second graphic element 21 remains invisible as long as the second label 20 and/or product 1 remain intact (i.e. untouched, uncorrupted), but becomes visible after the product has been open or after the second label 20 has been corrupted.

Other exemplary embodiments of this second label can be given.

This second label could be coated with a scratch-off ink, allowing the second graphic element 21 to be uncovered only once.

This second label could have two layers, including a back layer on which the second graphic element 21 would be written and a front protective layer, which can be peeled off the back layer only once.

Other alternative embodiments are obviously conceivable.

The two graphic elements 11, 21 are provided to encode data that are can be decoded using the application downloaded on the mobile phone 200, when photographed by this phone.

These two graphic elements 11, 21 could come in a variety of forms, as long as they are able to encode data.

It could be bar codes or two-dimensional codes. They are here typically QR-codes.

By “two-dimensional code”, it is meant a code in two dimensions, taking the form of a set of lines, squares, points, polygons or other geometric figures, which is used to encode information.

By “OR-code”, it is meant a type of two-dimensional bar code (or datamatrix code) consisted of black modules arranged in a square with a white background. The arrangement of these points defines the information contained in the code.

As will be described hereinafter, the first and second graphic elements 11, 21 encode a public key Kpub and a private key Kpri, respectively, which are associated with each other (in the sense of asymmetric cryptology).

The method allowing a Company B to market a product 1 that Customer C can authenticate will now be described in more detail.

The first step consists, for Company B, in obtaining a digital wallet 110.

Company B uses for that purpose a company terminal, here formed by a computer with the software Log provided by Trusted third party A.

This operation could be carried out using this software Log, with no previous check. However, here, Trusted third party A is responsible for controlling the company, and in particular the identity thereof, before issuing it a digital wallet 110.

This digital wallet 110 here includes a public key (hereinafter called address Adlio of the digital wallet 110 of Company B) and a private key K₁₁₀, associated with the public key in the sense of asymmetric cryptology. It further includes tokens that can be spent by Company B.

Trusted third party A controls in parallel the registration of this wallet issuance in the blockchain.

The data written in the blockchain at this step are in particular:
the identity of Company B, and
the address Ad₁₁₀, of the digital wallet 110 of Company B.

Other data relating to Company B can also be written. In our example in which Company B markets wine bottles, these data may for example relate to the year the winery was founded, its location, its soil, the products it markets . . . .

Once Company B in possession of its digital wallet 110, it is able to use the software Log to generate, for each product 1 marketed, a couple of public key Kpub and private key Kpri for authenticating this product 1. These keys are obviously unique (a same couple of keys cannot be used to sell products separately).

For the sake of clarity of description, only one product 1 will be discussed here.

Company B, before marketing this product 1, will further generate a first transaction S1 to be written in the blockchain (see FIG. 2), corresponding to the sale of product 1.

The data registered in the blockchain have then for objective to make this first transaction S1 public.

The data written in the blockchain during this first transaction S1 will comprise at least:
the address Ad₁₁₀, of the digital wallet 110 of Company B, and
the public key Kpub associated with product 1.

These data can be written in the blockchain only because Company B holds a private key K₁₁₀ that allows it to authenticate with the authentication and traceability servers 100.

During this writing operation, a token is then associated with the public key Kpub of product 1. As an alternative, it could be a token part or several tokens.

The private key Kpri is of course not written in the blockchain.

On the other hand, other data relating to Company B or to product 1 can be written in the blockchain during this first transaction S1. By way of example, it may be tracing information relating to product 1, such as for example a batch number, a production or bottling date . . . .

Company B, or a subcontractor of this company (typically, a label manufacturer), will then be able to print two labels 10, 20.

QR-code 11 written on the first label 10 is then designed to digitally encode the public key Kpub whereas QR-code 21 written on the second label 20 is designed to digitally encode the private key Kpri.

These two labels 10, 20 can then be affixed on product 1, as exposed hereinabove. In the example shown here, the first label 10 is stuck on the wine bottle in such a way that its QR-code 11 is visible, whereas the second label 20 is stuck on the wine bottle in such a way that its QR-code 21 is invisible.

It will be noted here that from one product 1 to another, all the QR-codes used are different.

At this stage, product 1 can be marketed. In our example, the case will be considered in which the wine bottle is offered for sale by a wine merchant.

The wine merchant and all their Customers C are then able to check product 1 authenticity by scanning the visible QR-code 11 with their mobile phone 200, if they have previously downloaded the dedicated application App (or, if they don't want to download this application, by using a Web interface via an Internet browser).

This application App will indeed allow Customers C and the wine merchant to check that the public key Kpub of product 1 is actually written in the blockchain, which will confirm product 1 authenticity. It also checks that the token associated with the product has actually been spent accordingly.

This authentication operation S2 has several advantages. It first allows checking that product 1 has actually been marketed by Company B. It further allows Customers C to find information about Company B and product 1, which has been written in the blockchain. It finally allows checking in the blockchain that the product has not already been sold to another customer (that would already have scanned the QR-code 21 associated with the private key).

When a Customer C wants to acquire product 1, they can start by paying the price of product 1, then corrupt the second label 20 in such a way as to make the QR-code 21 visible.

In the embodiment shown here, they peel off for that purpose the second label 20, which has the very obvious effect of damaging it (and making it unusable), and to make the QR-code 21 visible.

After having scanned the QR-code 11, the customer will then be able to scan this second QR-code 21 with their mobile phone 200.

Application App downloaded into the mobile phone 200 will thus allow checking that both public key Kpub and private key Kpri are actually associated with each other in the sense of the asymmetric cryptology, which will allow authenticating again, with a still greater reliability, product 1.

Indeed, it could be conceived that a counterfeiter uses copies of the first label on several products. The buyer, by scanning the QR-code 21 appearing on the second label will then check that both keys match, which allow them to control that this product is actually authentic and that it is not a copy.

To carry out this authentication, the blockchain protocol checks that the signature is valid (i.e. the keys are associated with each other), then, if this is the case, it grants access to the token associated with the public key Kpub of the product 1, which allows it to be spent. It is thus understood that the private key Kpri is essentially used to authenticate product 1 and to sign the transaction in order to write it in the blockchain.

The scanning operation S3 will thus automatically cause a second transaction S4 to be written on a new block 120 of the blockchain. This writing will allow this second transaction S4 to be made public in order to indicate that product 1 has been sold, which will prevent it being resold fraudulently.

The data that are for that purpose written in the blockchain include at least the public key Kpub of the product. They can also include other data, such as for example the address Ad₁₁₀, of the digital wallet 110 of Company B.

Preferentially, the writing of this second transaction S4 is automatically followed with at least one additional step.

The first additional step consists in transmitting to Company B information about Customer C who has bought product 1. For that purpose, the buyer may have entered personal information or information about the transaction itself (did it go smoothly?) on application App downloaded to their mobile phone 200.

These pieces of information are then transmitted by Internet to Company B. They are preferentially not written in the blockchain, in order not to be made public.

A second additional step could consist in issuing a guarantee associated with product 1. This is in particular the case if product 1 is an appliance subject to guarantee, typically an electronic device (television, telephone, washing machine . . . ). In this case, the guarantee can be transmitted to Company B and to Customer C, see also to Trusted third party A.

As an alternative, it could also be provided that the guarantee is written in the blockchain.

The advantage in using application App to generate this guarantee is that the data required to set up this guarantee (date of sale equal to date of second transaction, information required from the buyer, etc.) are already known and have thus not to be entered. The reason why these data are already known is that Customer C has entered their own personal data (name, address . . . ) when downloading application App and creating a personal account.

At this stage, it could be provided that any new transaction about the product 1 is ignored by application App. In this alternative, only the sale to Customer C would then be recognised as a valid change of ownership.

However, preferentially, it is here, on the contrary, provided to allow Customer C (hereinafter called “first buyer”) to resell product 1 to another buyer (hereinafter called “second buyer”), while allowing the second buyer to benefit from the authentication guarantees offered by the present invention.

Thus, product 1 may be subject to a third transaction, which will be written in the blockchain, then possibly also to other subsequent transactions. We can then describe how this is possible.

As explained hereinabove, when the first buyer registers product 1 by scanning the private key, the second transaction is registered in the blockchain. During this second transaction, a new address (i.e. a new public key) is generated for the product by application App and is registered in the blockchain (the associated private key is stored in application App of the first buyers mobile phone 200). This registration in the blockchain further stores the address of the first buyers wallet into the database of application App, so that the current owner of product 1 can be identified.

Before buying this product (during the third transfer), the second buyer can then check product 1 authenticity. For that purpose, the first buyer can use application App stored in their mobile phone to authorize a micro-transaction to and/or from the address of their associated product wallet (as recognized by application App) to the second buyers wallet, thus confirming being the rightful owner of the product. Then, once satisfied, the second buyer can request registration of the third transaction in the blockchain to prove that the ownership has been transferred to the second buyer.

The present invention is not in any way limited to the embodiment described and shown, but the person skilled in the art will know how to apply any variant in accordance with the invention.

1. A method for authenticating a product by means of a computer system including a computer register that is organized in a blockchain and in which data associated with computer wallet holders can be written, the method comprising:
generating a transaction, by a digital wallet holder, and registering said transaction in the computer register, said registration comprising at least one address of the digital wallet and a public key, said public key being associated with a private key, then
writing, on a first label, a first graphic element in which said public key is encoded,
writing, on a second label, distinct or not from the first label, a second graphic element in which said private key is encoded,
affixing the first and second labels on said product, in such a way that the first graphic element is visible and the second graphic element is invisible as long as said second label or the product remain intact, said product being authenticated by the first and second labels.

2. The authentication method according to claim 1, wherein one at least of the first and second graphic elements are in the form of a bar code or a two-dimensional code.

3. The authentication method according to claim 1, wherein said registration also comprises at least one other data item, which relates to the product or the manufacturer of said product.

4. A method for checking the authenticity of a product by means for a computer system including a computer register that is organized in a blockchain, wherein the product includes, on a first label, a first graphic element in which a public key is encoded, and, on a second label, distinct or not from the first label, a second graphic element in which a private key associated with said public key is encoded, said first graphic element being visible whereas the second graphic element is invisible as long as said second label or the product remain intact, said method comprising steps of:
making a preliminary check of the product authenticity by reading the first graphic element, decoding the public key and checking that the public key is registered in the computer register,
corrupting the second label or the product in such a way as to make the second graphic element visible,
making a complementary check of the product authenticity by reading the second graphic element, decoding the private key and checking that the decoded private key is actually associated with the decoded public key, wherein the private key decoding automatically causes the registration of a new transaction in the computer register.

5. The check method according to claim 4, wherein an additional step is provided, of acquiring data that relate to an individual acquiring said product and that have been previously entered on a man-machine interface.

6. The check method according to claim 4, wherein an additional step is provided, in which a guarantee associated with the product is generated.

7. The check method according to claim 5, wherein said additional step is automatically implemented after the complementary check step.

8. The check method according to claim 6, wherein said additional step is automatically implemented after the complementary check step.
